(19) United States
(12) Patent Application Publication
(10) Pub. No.: US 2019/0193123 A1
(43) Pub. Date: Jun. 27, 2019

(54) CLEANING DEVICE

(71) Applicants: IHI Corporation, Tokyo (JP); IHI Machinery and Furnace Co., Ltd., Tokyo (JP)

(72) Inventors: Masatoshi MITSUZUKA, Tokyo (JP); Noboru KIYA, Tokyo (JP); Takahiro NAGATA, Tokyo (JP)

(73) Assignees: IHI Corporation, Tokyo (JP); IHI Machinery and Furnace Co., Ltd., Tokyo (JP)

(21) Appl. No.: 16/291,109

(22) Filed: Mar. 4, 2019

Related U.S. Application Data
(63) Continuation of application No. PCT/JP2017/028760, filed on Aug. 8, 2017.

(30) Foreign Application Priority Data
Sep. 21, 2016 (JP) 2016-184298

(51) Int. Cl. B08B 3/04

(52) U.S. Cl. CPC B08B 3/04; F28B 1/02; B08B 2230/01

(57) ABSTRACT

A cleaning device includes at least: a main body including a vapor cleaning chamber configured to perform vapor-cleaning on a workpiece and a dipping cleaning chamber configured to perform dip-cleaning on the workpiece; and a condenser provided on the vapor cleaning chamber to be capable of switching between a communication state and a non-communication state with the vapor cleaning chamber via a vapor inlet port, and configured to condense vapor taken in from the vapor inlet port, in which the condenser includes: a condenser casing in which the vapor inlet port is formed; a cooling pipe through which a coolant flows; and a holding member that holds the cooling pipe to detachably house the cooling pipe in the condenser casing.

### CROSS-REFERENCE TO RELATED APPLICATIONS

This application is a continuation application based on a PCT Patent Application No. PCT/JP2017/028760, filed Aug. 8, 2017, which claims priority on Japanese Patent Application No. 2016-184298, filed Sep. 21, 2016, the contents of which are incorporated herein by reference.

### TECHNICAL FIELD

The present disclosure relates to a cleaning device.

### BACKGROUND

Patent Document 1 discloses a vacuum cleaning device, which includes a vapor cleaning chamber for vapor-cleaning of a workpiece (an object to be cleaned) and a dipping chamber for dip-cleaning of the workpiece, performs the vapor-cleaning on the workpiece in the vapor cleaning chamber and then performs the dip-cleaning on the workpiece in the dipping chamber, and performs a drying treatment on the workpiece in the vapor cleaning chamber without using a vacuum pump by forcing a condensing chamber under a reduced pressure to communicate with the vapor cleaning chamber. A cleaning device that adopts the same drying mode as in Patent Document 1 is disclosed in Patent Documents 2 and 3. Further, a vacuum degreasing and cleaning device and a vacuum cleaner that adopt the same cleaning mode as in Patent Document 1 are disclosed in Patent Documents 4 and 5.

Patent Document 1: Japanese Patent No. 5695762

Patent Document 2: Japanese Unexamined Patent Application, First Publication No. 2016-010776

Patent Document 3: Japanese Unexamined Patent Application, First Publication No. 2016-011805

Patent Document 4: Japanese Unexamined Patent Application, First Publication No. H06-220672

Patent Document 5: Japanese Unexamined Patent Application, First Publication No. 2003-236479

### SUMMARY

Meanwhile, in the drying mode of Patent Documents 1 to 3, the workpiece is dried by forcing the condensing chamber (the drying chamber) under a reduced pressure to communicate with the vapor cleaning chamber (the cleaning chamber), and thus moving grit and dust present in the vapor cleaning chamber (the cleaning chamber) to the condensing chamber (the drying chamber) along with a cleaning solvent vaporized in a vapor cleaning chamber (a cleaning chamber). Since the grit and dust attached to the inside of the condensing chamber (the drying chamber) reduce condensation performance for vapor of the cleaning solvent, they need to be removed.

However, in the condensing chamber (the drying chamber) of Patent Documents 1 to 3, since maintainability thereof is not taken into consideration, the grit and dust attached to the inside of the condensing chamber or the drying chamber cannot be easily removed. In the cleaning device that adopts the drying mode using the condensing chamber (the drying chamber) under a reduced pressure, it is extremely important to improve the maintainability of the condensing chamber (the drying chamber) in view of practical use.

The present disclosure was made in view of the above circumstances, and it is an object thereof to improve of a condenser the maintainability over the related art.

A cleaning device according to an aspect of the present disclosure includes: a main body including a vapor cleaning chamber configured to perform vapor-cleaning on a workpiece and a dipping cleaning chamber configured to perform dip-cleaning on the workpiece; and a condenser provided on the vapor cleaning chamber to be capable of switching between a communication state and a non-communication state with the vapor cleaning chamber via a vapor inlet port, and configured to condense vapor taken in from the vapor inlet port, in which the condenser includes: a condenser casing in which the vapor inlet port is formed; a cooling pipe through which a coolant flows; and a holding member that holds the cooling pipe to detachably house the cooling pipe in the condenser casing.

According to the present disclosure, since the cooling pipe is detachably housed in the condenser casing, easy access to the inside of the cooling pipe or the condenser casing is possible by detaching the cooling pipe from the condenser casing, and therefore the maintainability can be improved over the related art. According to the present disclosure, it is possible to easily remove grit and dust attached to the surface of the cooling pipe when, for example, vapor is condensed on the surface of the cooling pipe of the condenser, or grit and dust attached to the inner surface of the condenser casing when the vapor is condensed on the inner surface of the condenser casing of the condenser.

### BRIEF DESCRIPTION OF DRAWINGS

FIG. 1 is a sectional view of a vacuum cleaning device according to an embodiment of the present disclosure in a leftward/rightward direction.

FIG. 2 is a sectional view of the vacuum cleaning device according to the embodiment of the present disclosure in a forward/backward direction.

FIG. 3 is an enlarged longitudinal sectional view of a part of the vacuum cleaning device according to the embodiment of the present disclosure.

FIG. 4 is a side view of the vacuum cleaning device according to the embodiment of the present disclosure from behind.

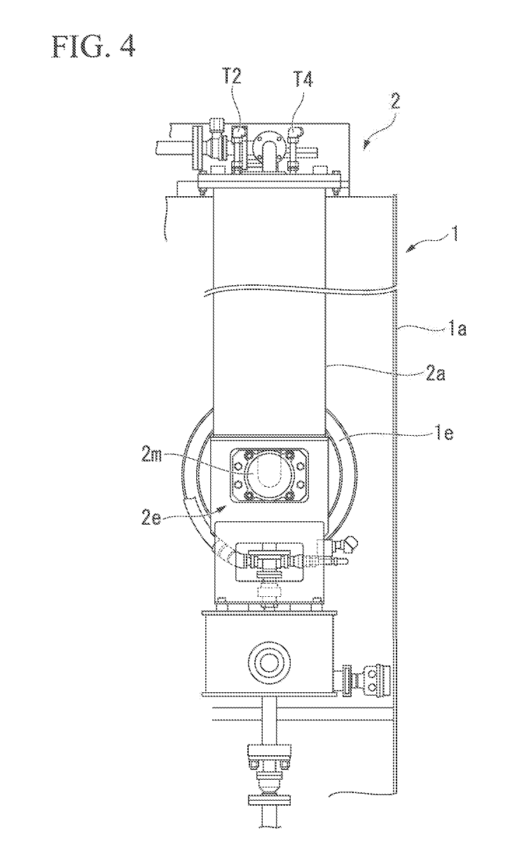

FIG. 5A is a top view of a condenser according to an embodiment of the present disclosure.

FIG. 5B is a longitudinal sectional view of the condenser according to the embodiment of the present disclosure.

FIG. 6 is a sectional view showing a cleaning process in the vacuum cleaning device according to the embodiment of the present disclosure.

FIG. 7 is a sectional view showing a cleaning process in the vacuum cleaning device according to the embodiment of the present disclosure.

FIG. 8 is a sectional view showing a cleaning process in the vacuum cleaning device according to the embodiment of the present disclosure.

FIG. 9 is a sectional view showing a cleaning process in the vacuum cleaning device according to the embodiment of the present disclosure.

FIG. 10 is a sectional view showing a cleaning process in the vacuum cleaning device according to the embodiment of the present disclosure.

FIG. 11 is a sectional view showing a cleaning process in the vacuum cleaning device according to the embodiment of the present disclosure.

FIG. 12 is a sectional view showing a cleaning process in the vacuum cleaning device according to the embodiment of the present disclosure.

### DESCRIPTION OF EMBODIMENTS

Hereinafter, an embodiment of the present disclosure will be described with reference to the drawings.

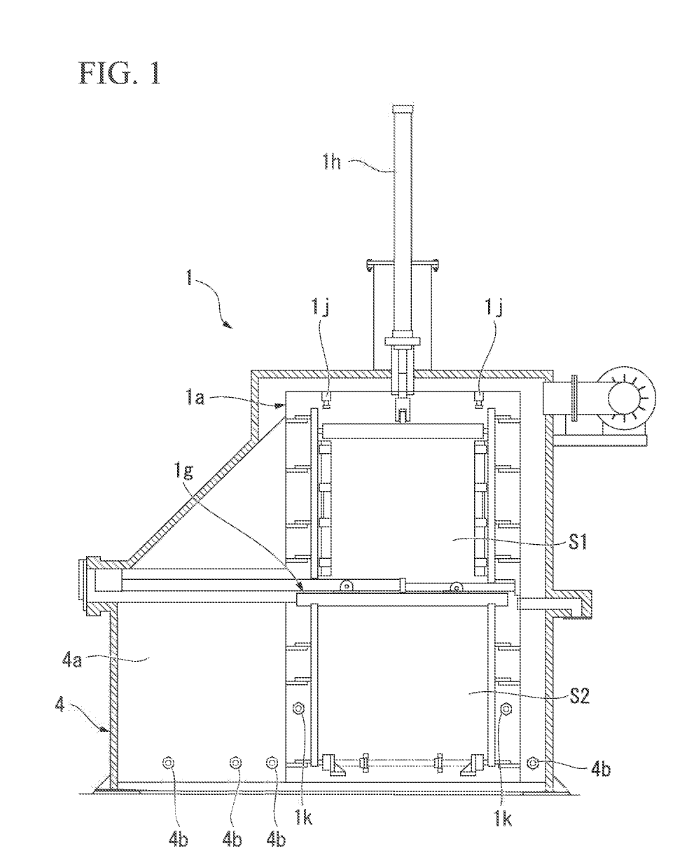

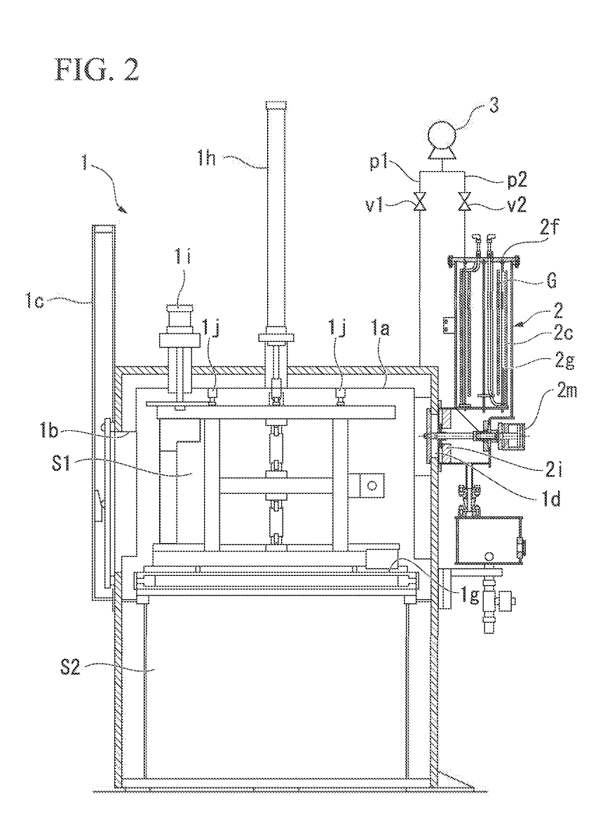

As shown in FIGS. 1 and 2, a vacuum cleaning device according to the present embodiment includes a cleaner (a main body) 1, a condenser 2, a vacuum pump 3, and a vaporiser 4. The vacuum cleaning device according to the present embodiment includes various devices, for example a regeneration concentrator acting as an auxiliary device, in addition to the cleaner 1, the condenser 2, the vacuum pump 3, and the vaporiser 4.

The cleaner 1 is a device that forces vapor of a cleaning solvent (vaporized cleaning solvent) to act on a workpiece W to which a dirt component is attached, then dips the workpiece W in the cleaning solvent, and thereby cleans the workpiece W.

That is, the cleaner 1 continuously receives vaporized cleaning solvent generated by the vaporiser 4 over a predetermined period (a cleaning period), continues to perform attachment of the vaporized cleaning solvent on a surface of the workpiece W housed in a cleaning chamber S1 and condensation of the vaporized cleaning solvent, and thereby washes away the dirt component attached to the surface of the workpiece W from the surface of the workpiece W along with a condensate of the cleaning solvent. Furthermore, the cleaner 1 dips the workpiece W in a cleaning solvent stored in a dipping chamber S2, thereby removing dirt attached to fine portions of the workpiece W, and performs shower cleaning on the workpiece W in the cleaning chamber S1 again, thereby washing away the dirt.

The workpiece W is, for example, a metal part, to a surface of which cutting oil or the like as a dirt component is attached in machining. The cleaning solvent is a hydrocarbon-based cleaning solvent, for example, a normal paraffin-based, isoparaffin-based, naphthene-based, or aromatic hydrocarbon-based cleaning solvent. More specifically, the cleaning solvent is a class 3 petroleum cleaning solvent such as TeClean (registered trademark) N20, Clean Sol G, or Dapheny Solvent, which are called cleaning solvents.

As shown in the drawings, the cleaner 1 includes a cleaner casing 1a in which the cleaning chamber (the vapor cleaning chamber) S1 and the dipping chamber (the dipping cleaning chamber) S2 are formed. The cleaner casing 1a is formed in a hollow cuboid shape (approximately a box shape) as a whole, and an internal space thereof is vertically divided into the cleaning chamber S1 and the dipping chamber S2 by a middle door 1g (to be described below). A workpiece insertion port 1b is provided in a front surface of the cleaner casing 1a. The workpiece insertion port 1b is an opening extending in a vertical direction and used for taking in and out the workpiece W between the cleaner casing 1a (i.e., the cleaner 1) and an exterior, and is closed or opened by a vertically movable front door 1c. The vacuum pump 3 is connected to the cleaner casing 1a via a control valve, and it is possible to set an atmosphere of the cleaning chamber S1 to a vacuum atmosphere (a decompressed atmosphere) of a predetermined pressure.

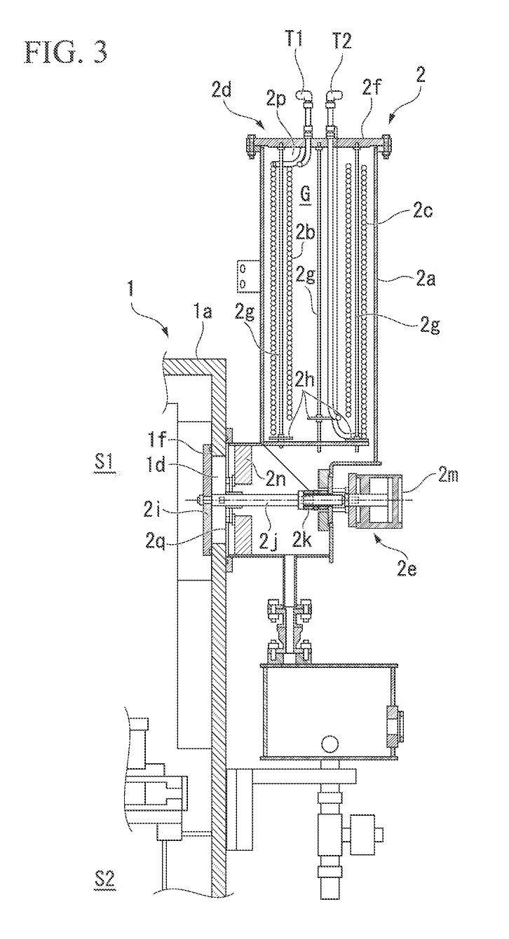

As shown in FIG. 2, a communication port 1d for forcing the cleaning chamber S1 that is an internal space of the cleaner 1 to communicate with a condensing chamber G that is an internal space of the condenser 2 is formed in a lateral surface (a rear surface or a right lateral surface in FIG. 2) of the cleaner casing 1a on which the condenser 2 is mounted. As shown in FIG. 3, the communication port 1d is a circular opening that is formed in a part of the cleaner casing 1a. A surface of the cleaner casing 1a around the communication port 1d, which comes into contact with a valve body 2i (to be described below), constitutes a valve seat 1f. The valve seat 1f will be described below in detail.

Furthermore, the cleaner 1 includes the middle door 1g, an elevating mechanism 1h, a vapor introduction damper 1i, shower nozzles 1j, and a dipping chamber heater 1k. The middle door 1g is a plate member that divides the cleaner casing 1a into the cleaning chamber S1 and the dipping chamber S2 in an upward/downward direction. When the middle door 1g is closed, the cleaning chamber S1 becomes a sealed space separated from the dipping chamber. The elevating mechanism 1h is a mechanism that raises/lowers the workpiece W between the cleaning chamber S1 and the dipping chamber S2 inside the cleaner casing 1a.

The vapor introduction damper 1i is connected to a cleaning solvent storage tank 4a (to be described below) of the vaporiser 4, and is also connected to the cleaning chamber S1. The vapor introduction damper 1i is a mechanism that can regulate a degree of opening of a flow passage of the vaporized cleaning solvent that flows from the vaporiser 4 toward the cleaning chamber S1 to adjust a flow rate of the vaporized cleaning solvent introduced into the cleaning chamber S1. The shower nozzles 1j are provided above the cleaning chamber S1 and discharge the cleaning solvent supplied from the cleaning solvent storage tank 4a into the cleaning chamber S1. The shower nozzles 1j are connected to the cleaning solvent storage tank 4a of the vaporiser 4 by a pipeline (not shown), and the pipeline is opened/closed by a valve. The dipping chamber heater 1k is buried in a lower sidewall of the cleaner casing 1a and heats the cleaning solvent in the dipping chamber S2.

A bubbling pipe (not shown) is provided below the dipping chamber S2 in the cleaner casing 1a. Air (outside air) flows into the bubbling pipe, and is discharged from a discharge port provided in the dipping chamber S2. A bubbling valve (not shown) is provided on a discharge port of the bubbling pipe.

The condenser 2 is a device that has an approximately columnar shape as shown in the drawings, and takes in the vapor in the cleaning chamber S1 through the communication port 1d to condense (liquefy) the vapor. In a state in which cleaning of the workpiece W is terminated in the cleaner 1, the cleaning solvent is attached to a surface of the workpiece W and an inner surface of the cleaner casing 1a.

Although the details will be described below, the condenser 2 vaporizes the cleaning solvent that remains in the cleaning chamber S1 (especially the cleaning solvent attached to the surface of the workpiece W) after the cleaning of the workpiece W into vapor (residual vapor), and moves the residual vapor from the cleaning chamber S1 to the condensing chamber to condense (liquefy) the residual vapor.

The condenser 2 includes a condenser casing 2a, two cooling coils (cooling pipes) 2b and 2c, a holding member 2d, and an opening/closing mechanism 2e. Among the components of the condenser 2, the holding member 2d includes a lid member 2f, a plurality of rod members 2g, and a plurality of locking members 2h, and the opening/closing mechanism 2e includes a valve body 2i, a connecting rod 2j, a bearing member 2k, an air cylinder 2m, and a guide member 2n.

The condenser casing 2a is a hollow columnar member that has an approximately cylindrical shape and is fixed to the cleaner casing 1a in a vertical posture. That is, the condenser casing 2a is mounted on the cleaner casing 1a such that an axis of the condenser casing 2a is vertical. An upper end portion of the condenser casing 2a is a circular release end 2p, and a lower end portion of the condenser casing 2a includes a circular vapor inlet port (a circular opening) 2q which faces the communication port (a circular opening) 1d of the cleaner casing 1a located on a side (in the front) of the condenser casing 2a and whose diameter is slightly larger than that of the communication port 1d. A drain port is provided in a lower portion of the condenser casing 2a. A used cleaning solvent (to be described below) is discharged to a storage container provided below the condenser casing 2a.

The two cooling coils 2b and 2c are coil-shaped cooling pipes in which a direction of a winding axis is a direction of the axis (i.e., a vertical direction) of the condenser casing 2a and a coolant flows through the cooling coils 2b and 2c. The two cooling coils 2b and 2c are provided at a predetermined interval in a direction perpendicular to the axis of the condenser casing 2a, that is, in two rows adjacent to each other in a horizontal direction. That is, the cooling coil 2b of the two cooling coils 2b and 2c is provided at a position close to the axial center of the condenser casing 2a, and the cooling coil 2c is provided at a position further from the axial center of the condenser casing 2a than the cooling coil 2b. The coolant may be any liquid as long as it can be held in the condensing chamber at a temperature below a boiling point of the cleaning solvent under a reduced pressure.

The holding member 2d holds the two cooling coils 2b and 2c, and detachably houses the two cooling coils 2b and 2c in the condenser casing 2a. That is, the holding member 2d includes the lid member 2f that blocks the release end (an attachment/detachment port) 2p formed at the condenser casing 2a, the plurality of rod members 2g one ends (upper ends) of which are fixed to the lid member 2f, and the plurality of locking members 2h that are provided in predetermined places of the rod members 2g and lock the two cooling coils 2b and 2c.

The lid member 2f is a disk-shaped member that constitutes a part of the condenser casing 2a, and is detachably fixed to the release end 2p of the condenser casing 2a by a plurality of fasteners made up of, for example, bolts and nuts. The rod members 2g are long studs extending in a vertical direction. The upper ends of the rod members 2g are screwed into a plurality of bolt holes that are formed in the lid member 2f to be apart from each other, and the locking members 2h are screwed onto lower ends of the rod members 2g. The plurality of locking members 2h are plates in which bolt holes into which the lower ends of the rod members 2g are screwed are formed, protrude to sides of the rod members 2g extending in the vertical direction, that is, protrude in a horizontal direction, and are engaged with lower ends of the cooling coils 2b and 2c.

Here, ends (four ends in total) of the two cooling coils 2b and 2c constitute external connection ports T1 to T4 that are drawn to an upper side of the lid member 2f, that is, to an outside of the condenser casing 2a, via through-holes formed in the lid member 2f. Among the four external connection ports T1 to T4, the external connection port T1 is one end of the one cooling coil 2b, and the external connection port T2 is the other end of the one cooling coil 2b. The external connection port T3 is one end of the other cooling coil 2c, and the external connection port T4 is the other end of the other cooling coil 2c.

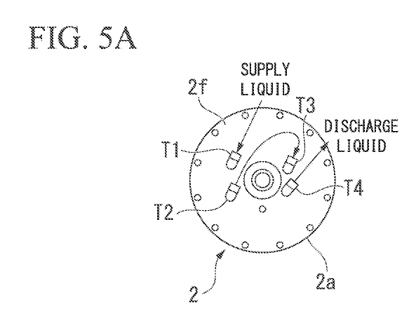

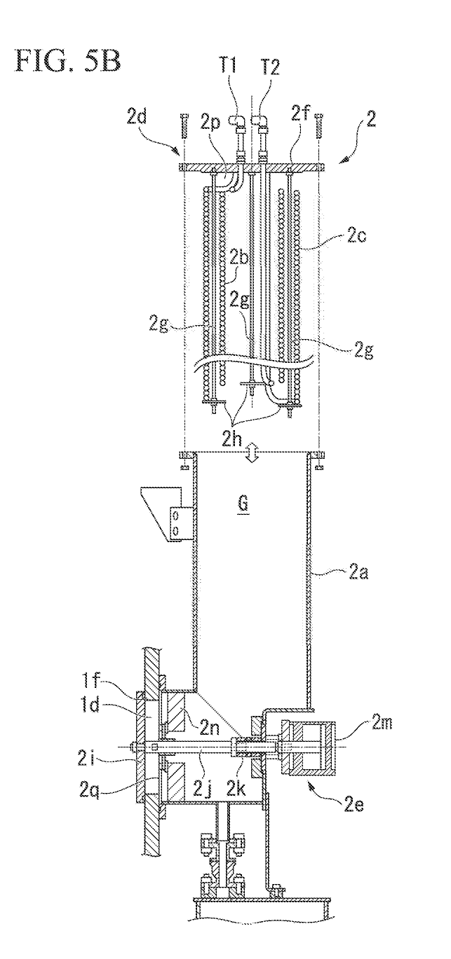

That is, the condenser 2 according to the present embodiment is configured to be capable of setting a connection relationship between the two cooling coils 2b and 2c outside the condenser 2. For example, as shown in FIG. 5A, in the case where the external connection ports T2 and T3 are connected to each other and the coolant is supplied to the external connection port T1 and is discharged from the external connection port T4, the one cooling coil 2b and the other cooling coil 2c are connected in series, and the coolant flows to a path that passes through the one cooling coil 2b and then passes through the other cooling coil 2c. In this case, since the one cooling coil 2b and the other cooling coil 2c are connected in series, the passing path of the coolant is simple.

Meanwhile, in the case where a branch supply pipe is used to supply the coolant to the external connection ports T1 and T3 in parallel and to discharge the coolant from the external connection ports T2 and T4, the one cooling coil 2b and the other cooling coil 2c are connected in parallel, and the coolant flows to the one cooling coil 2b and the other cooling coil 2c in parallel. In this case, since the one cooling coil 2b and the other cooling coil 2c are connected in parallel, pressure loss becomes smaller than in the case shown in FIG. 5A, and thus the coolant can be made to flow at a relatively low supply pressure.

The opening/closing mechanism 2e directly closes or opens the communication port 1d of the cleaner casing 1a, and thereby indirectly opens/closes the vapor inlet port 2q of the condenser casing 2a. That is, as shown in FIG. 3, the opening/closing mechanism 2e includes the valve body (the disk-shaped member) 2i that is located in the cleaner casing 1a and has a larger diameter than the communication port 1d. The valve body 2i comes into close contact with the valve seat 1f or is separated from the valve seat 1f, and thereby the cleaning chamber S1 and the condensing chamber G are switched between a non-communication state and a communication state.

The connecting rod 2j is a rod member, one end (a front end) of which is coupled to the center of the valve body 2i in a vertical posture, and the other end (a rear end) of which is coupled to a movable piece of the air cylinder 2m. The bearing member 2k slidably supports the connecting rod 2j in a longitudinal direction thereof, and is fixed to the condenser casing 2a. The air cylinder 2m is a driving source for the valve body 2i, that is, the air cylinder 2m is configured to make the valve body 2i come in close contact with the valve seat 1f or be separated from the valve seat 1f, and drives the valve body 2i by supporting the valve seat 1f via the connecting rod 2j.

Here, to reliably close the communication port 1d (i.e., the vapor inlet port 2q) with the valve body 2i, an outer circumferential portion of the valve body 2i needs to come into contact with the valve seat 1f over the entire circumference. Therefore, the center of the valve body 2i that is a disk-shaped member and the center of the valve seat 1f that is a circular opening need to be aligned. When positions of the center of the valve body 2i and the center of the valve seat 1f deviate extremely, a part of the outer circumferential portion of the valve body 2i is not in contact with the valve seat 1f, and therefore the valve body 2i cannot completely close the communication port 1d (i.e., the vapor inlet port 2q).

The guide member 2n is provided to realize this alignment of the valve body 2i and the valve seat 1f. The guide member 2n is an approximately disk-shaped member that is press-fitted into a halfway portion of the connecting rod 2j in a longitudinal direction, and faces the valve body 2i in parallel at a predetermined distance. An outer circumferential portion of the guide member 2n is slidably brought into contact with an inner circumferential surface of a portion (a cylindrical portion that is directed forward (i.e., in a leftward/rightward direction in FIGS. 3 and 5B)) around the vapor inlet port 2q in the condenser casing 2a. Thereby, the center of the connecting rod 2j is aligned with the center of the vapor inlet port (the circular opening) 2q, and the entire circumference of the outer circumferential portion of the valve body 2i is brought into contact with the valve seat 1f.

As shown in FIG. 2, the vacuum pump 3 is a device that is connected to the cleaning chamber S1 of the cleaner 1 and the condenser 2 and evacuates gases in the cleaning chamber S1 and the condenser 2, and thereby converts pressures of the cleaner 1 and the condenser 2 into negative pressures. A first vacuum valve v1 is provided on a connection pipe p1 between the vacuum pump 3 and the cleaner 1, and a second vacuum valve v2 is provided on a connection pipe p2 between the vacuum pump 3 and the condenser 2.

As shown in FIG. 1, the vaporiser 4 includes the cleaning solvent storage tank 4a and a vapor generating heater 4b. The cleaning solvent storage tank 4a is provided outside the cleaner casing 1a, and the cleaning solvent discharged from the vapor introduction damper 1i and the shower nozzles 1j to the cleaning chamber S1 is stored therein. The cleaning solvent that is recovered by the condenser 2 and is regenerated by a regeneration condenser flows into the cleaning solvent storage tank 4a. The vapor generating heater 4b heats the cleaning solvent stored in the cleaning solvent storage tank 4a, and is installed inside the cleaning solvent storage tank 4a. This vaporiser 4 generates the vaporized cleaning solvent used for a vapor-cleaning treatment by heating the cleaning solvent stored in the cleaning solvent storage tank 4a.

Operations of the vacuum cleaning device having the cleaner 1 and the condenser 2 are automatically controlled by a control device (not shown). The vacuum cleaning device is used in a state in which a periphery thereof is covered by an external cladding.

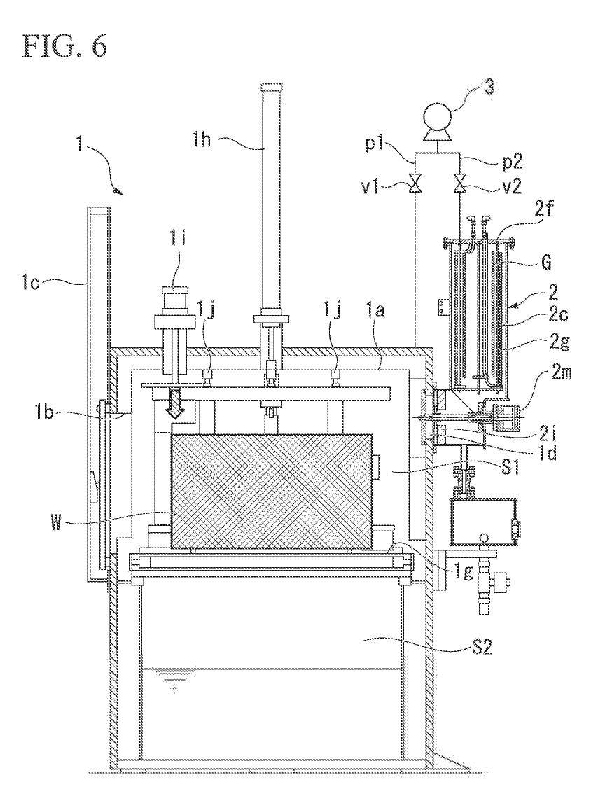

Next, the operations of the vacuum cleaning device configured in this way will be described with reference to FIGS. 6 to 13.

When the workpiece W is cleaned using the vacuum cleaning device, the workpiece W is housed in the cleaning chamber S1 from the workpiece insertion port 1b provided in the cleaner casing 1a as shown in FIG. 6. A dirt component such as cutting oil is attached to the surface of the workpiece W. The front door 1c provided on the cleaner casing 1a is driven, and thereby the cleaning chamber S1 becomes a sealed space.

In this state, first, the opening/closing mechanism 2e sets the cleaning chamber S1 and the condensing chamber G in a communication state. In this state, the vacuum pump 3 is operated. Thereby, the cleaning chamber S1 and the condensing chamber G are gradually decompressed, and are set to, for example, a pressure (an initial pressure) of 10 kPa or lower.

In parallel to the decompressing treatment of the cleaning chamber S1 and the condensing chamber G, the vaporiser 4 is operated, and vaporized cleaning solvent is generated. The vaporized cleaning solvent has a pressure that is a saturated vapor pressure, and a temperature that is around a boiling point of the cleaning solvent under a reduced pressure, for example 80 to 140° C. When the decompressing treatment is completed, the opening/closing mechanism 2e is operated. Thereby, the cleaning chamber S1 and the condensing chamber G are switched from the communication state to a non-communication state, and the cleaning chamber S1 and the condensing chamber G become individual sealed spaces. A coolant is supplied to the condenser 2 from outside, and thereby a temperature of the condensing chamber G is held at a constant temperature. In the case where water (tap water) is used as the coolant, the temperature of the condensing chamber G is held below a boiling point of the cleaning solvent.

After this pretreatment, a vapor-cleaning treatment is performed. The vaporized cleaning solvent is supplied from the vaporiser 4 to the cleaning chamber S1 via the vapor introduction damper 1i over a predetermined cleaning period. Thereby, the workpiece W in the cleaning chamber S1 is cleaned. That is, attachment and condensation of the vaporized cleaning solvent are continuously repeated on the surface of the workpiece W over the predetermined cleaning period, and the dirt component attached to the surface of the workpiece W is removed (cleaned) by falling down from the surface of the workpiece W along with a condensate of the vaporized cleaning solvent.

When this vapor-cleaning treatment of the workpiece W is terminated, the cleaning chamber S1 has a pressure (a cleaning chamber pressure) that is nearly equal to the saturated vapor pressure of the vaporized cleaning solvent, and a temperature (about 80 to 140° C.) that is nearly equal to the temperature of the vaporized cleaning solvent. That is, the cleaning chamber pressure and the cleaning chamber temperature are values that are considerably higher than preset held pressure and temperature of the condensing chamber G (a condensing chamber pressure and a condensing chamber temperature).

A drying treatment of the workpiece W in the cleaning chamber S1 is followed by the vapor-cleaning treatment. In this drying treatment, the opening/closing mechanism 2e is operated, and thereby the cleaning chamber S1 and the condensing chamber G that have the above-described pressure relationship and temperature relationship communicate with each other. That is, the air cylinder 2m is operated to separate the valve body 2i from the valve seat 1f, and thereby the cleaning chamber S1 and the condensing chamber G is changed from the non-communication state to the communication state.

As a result, the pressure (the cleaning chamber pressure) of the cleaning chamber S1 is rapidly decompressed, and the condensate (the residual liquid) of the vaporized cleaning solvent attached to the surface of the workpiece W is instantly boiled (suddenly boiled) due to the rapid decompression. The cleaning chamber S1 and the condensing chamber G are connected in a short time and by a relatively wide area. Thereby, vapor (residual vapor) of the residual liquid separated from the surface of the workpiece W moves, at a high speed, from the cleaning chamber S1 (a high pressure side) to the condensing chamber G (a low pressure side) via a gap between the valve body 2i and the valve seat 1f, the communication port 1d, and the vapor inlet port 2q.

The residual vapor moving to the condensing chamber G (the low pressure side) is attached to surfaces of the two cooling coils 2b and 2c, and thereby is recondensed into a used cleaning solvent. The used cleaning solvent is dropped downward from the surfaces of the two cooling coils 2b and 2c, and is slightly collected at the lower portion of the condenser casing 2a, and is discharged into the storage container from the drain port provided at the lower portion.

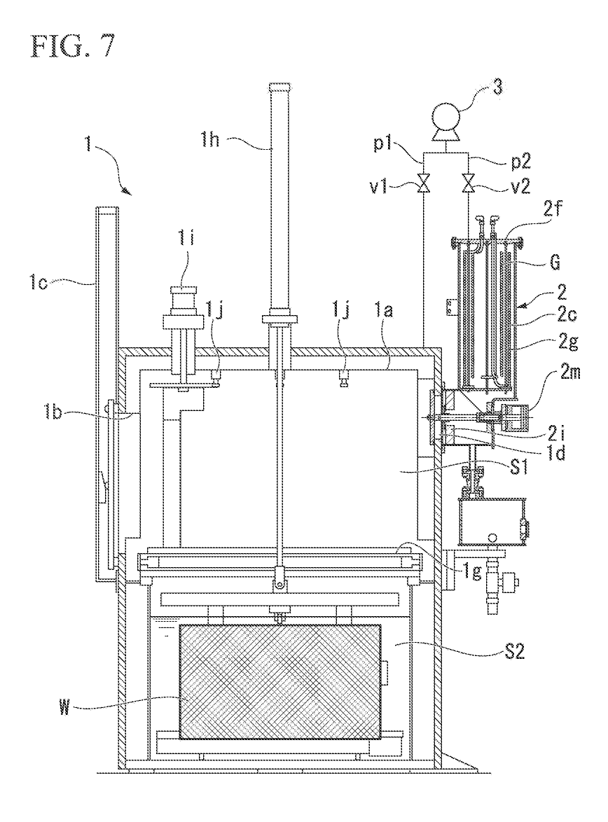

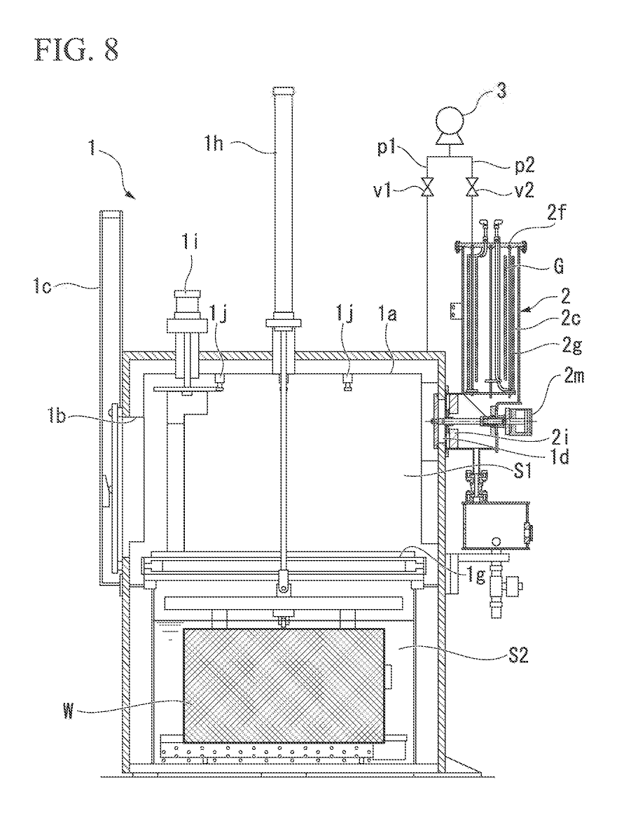

When the drying treatment is completed, a dip-cleaning treatment is performed. First, when the cleaning solvent is discharged, the valve body 2i of the condenser 2 comes into contact with the valve seat 1f, and the cleaning chamber S1 and the condensing chamber G are put in the non-communication state. After the cleaning chamber S1 is returned to the initial pressure, the middle door 1g is opened, and the cleaning chamber S1 and the dipping chamber S2 are put in the communication state. A cleaning solvent is supplied to the dipping chamber S2, and as the elevating mechanism 1h is lowered, the workpiece W from which the cleaning solvent is removed is dipped in the cleaning solvent of the dipping chamber S2 as shown in FIG. 7. The cleaning solvent supplied to the dipping chamber S2 is heated by the dipping chamber heater 1k. The bubbling valve is opened, and a gas is discharged into the cleaning solvent from the bubbling pipe as shown in FIG. 8. Thereby, bubbles are generated in the cleaning solvent. The cleaning solvent flows into fine portions of the workpiece W in this dipping chamber S2, and furthermore the bubbles are attached to the surface of the workpiece W. Thereby, a dirt that cannot be removed in the vapor-cleaning treatment is removed. At the same time as the dip-cleaning treatment, in the condenser 2, the inside of the condensing chamber G is decompressed by the vacuum pump 3 and cooled, and thereby is returned to a state of the condensing chamber G prior to the drying treatment.

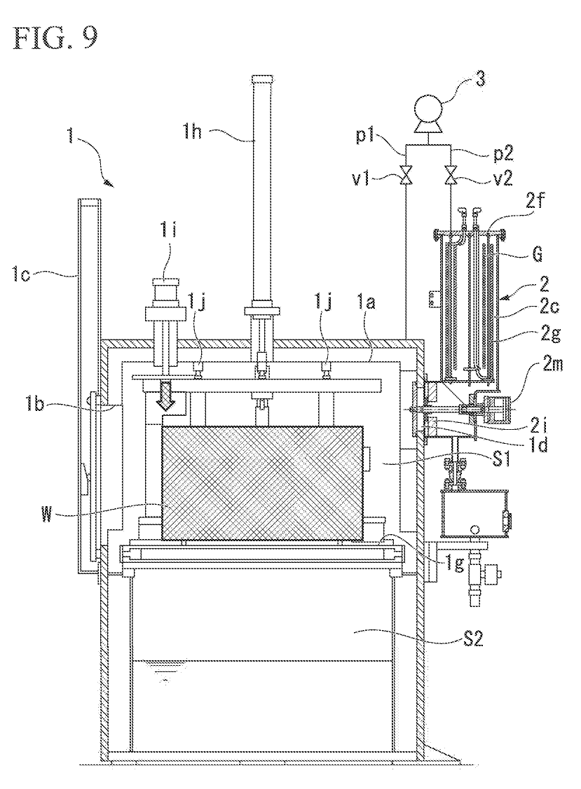

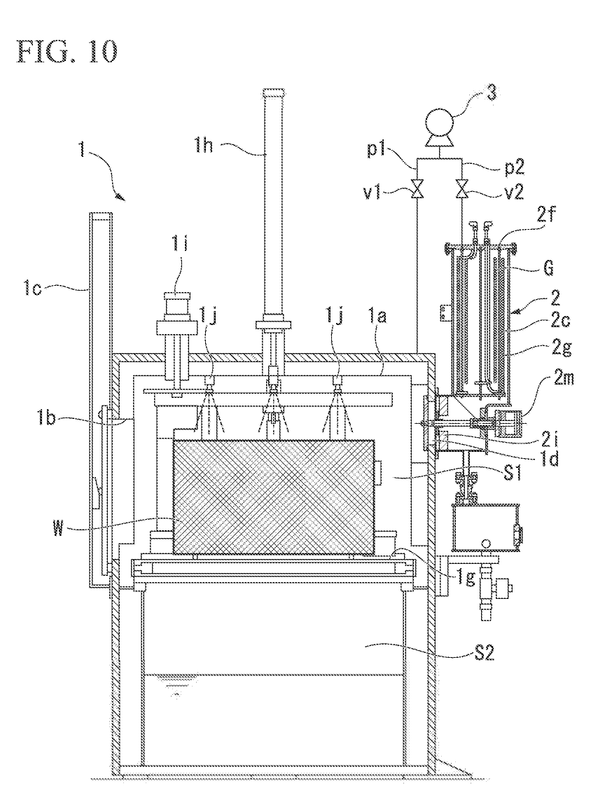

Furthermore, as shown in FIG. 9, when the elevating mechanism 1h is raised again to return the workpiece W to the cleaning chamber S1, the middle door 1g is closed, and thereby the cleaning chamber S1 is sealed. The valve body 2i of the condenser 2 is separated from the valve seat 1f again, and thereby the cleaning chamber S1 and the condensing chamber G are put in the communication state, and a drying treatment is performed. When the drying treatment is completed, the valve body 2i of the condenser 2 comes into contact with the valve seat 1f, and the cleaning chamber S1 and the condensing chamber G are put in the non-communication state. As shown in FIG. 10, a shower cleaning treatment is performed on the workpiece W after the drying treatment. In the shower cleaning treatment, the cleaning solvent stored in the cleaning solvent storage tank 4a is discharged from the shower nozzles 1j to the cleaning chamber S1, and thereby the dirt of the surface of the workpiece W is washed out. At the same time as the shower cleaning treatment, in the condenser 2, the inside of the condensing chamber G is decompressed by the vacuum pump 3 and cooled, and thereby is returned to the state of the condensing chamber G prior to the drying treatment.

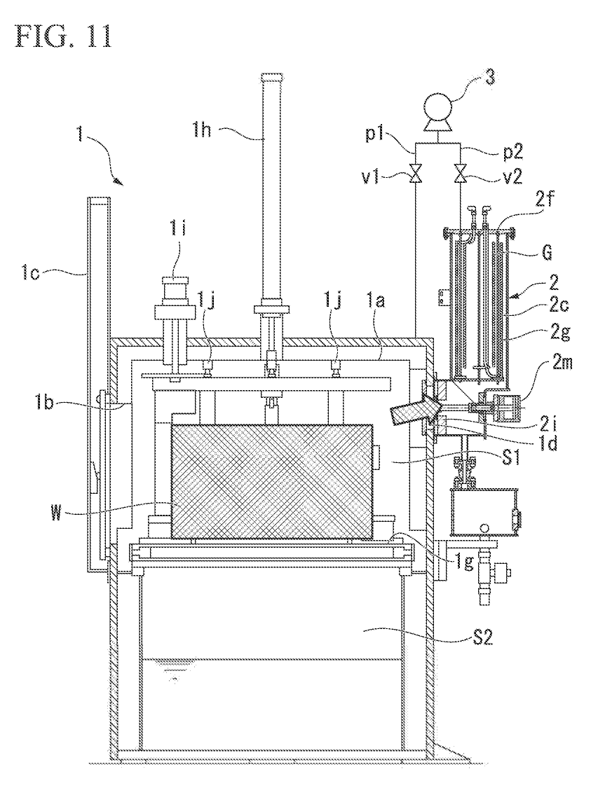

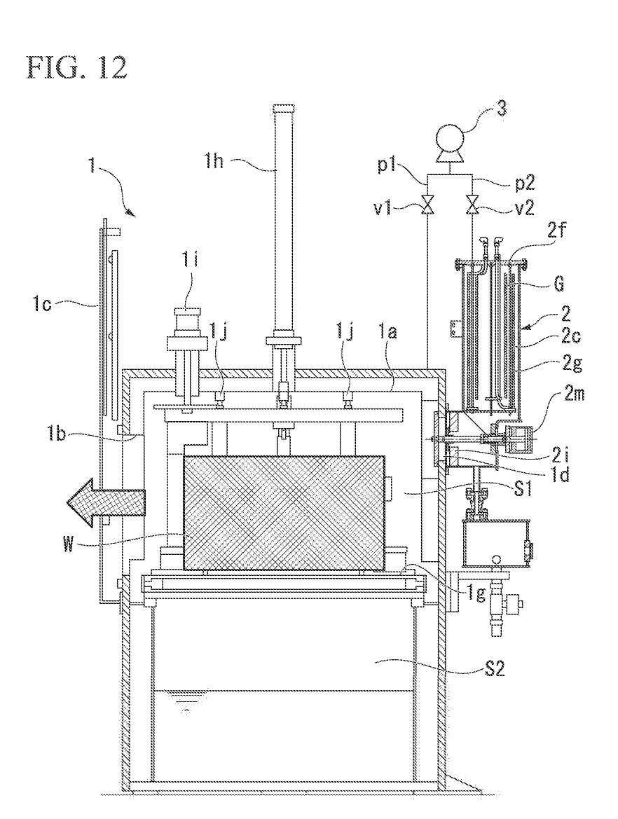

When the shower cleaning treatment is completed, the valve body 2i of the condenser 2 is separated from the valve seat 1f again as shown in FIG. 11, and thereby the cleaning chamber S1 and the condensing chamber G are put in the communication state, and a drying treatment is performed (in this case, as indicated by an arrow in the figure, residual vapor separated from the surface of the workpiece W moves from the cleaning chamber S1 to the condensing chamber G (the low pressure side) via the gap between the valve body 2i and the valve seat 1f, the communication port 1d, and the vapor inlet port 2q). When the drying treatment is terminated, the valve body 2i of the condenser 2 comes into contact with the valve seat 1f, and the cleaning chamber S1 and the condensing chamber G are put in the non-communication state. Furthermore, an atmospheric opening valve (not shown) is opened, and outside air flows into the cleaning chamber S1, and the inside of the cleaning chamber S1 is returned to an atmospheric pressure condition. As shown in FIG. 12, the front door 1c is opened, and the workpiece W is carried out as indicated by an arrow in the figure.

As the dip-cleaning treatment is performed, even the workpiece W having a shape in which the vaporized cleaning solvent is difficult to reach fine portions, for example the workpiece W at which recesses are formed, can be sufficiently cleaned. As described above, as the drying treatment is performed during the vapor-cleaning treatment, the dip-cleaning treatment, and the shower cleaning treatment, removal performance of the dirt caused by the cleaning treatment can be improved.

According to this vacuum cleaning device of the present embodiment, as the cleaning chamber S1 and the condensing chamber G are switched from the non-communication state to the communication state, the residual liquid attached to the workpiece W in the cleaning chamber S1 is gasified and removed, and the workpiece W is rapidly dried in a relatively short time.

Here, when the residual vapor generated in the cleaning chamber S1 moves to the condensing chamber G and is recondensed into an used cleaning solvent, the grit and dust remaining in the cleaning chamber S1 move to the condensing chamber G along with the residual vapor, and are attached to the surfaces of the two cooling coils 2b and 2c and the inner surface of the condenser casing 2a. An amount of the attachment of the grit and dust increases depending on an operating time of the vacuum cleaning device. The grit and dust attached to the surfaces of the two cooling coils 2b and 2c and the inner surface of the condenser casing 2a are main causes of reducing a condensing capacity of the condenser 2, and thus efficiently removing the grit and dust is extremely important matter for operating the vacuum cleaning device.

In view of this circumstance, in the condenser 2 according to the present embodiment, since the two cooling coils 2b and 2c can be detached from the condenser casing 2a along with the holding member 2d, that is, the two cooling coils 2b and 2c housed in the condenser casing 2a are freely attached/detached to/from the condenser casing 2a, the cooling coils 2b and 2c are detached from the condenser casing 2a, and the grit and dust can be efficiently removed. That is, the vacuum cleaning device according to the present embodiment has more excellent maintainability than the conventional vacuum cleaning device.

In the condenser 2 according to the present embodiment, since the condenser casing 2a has a columnar shape, and the two cooling coils 2b and 2c are formed in a coil shape in which the direction of the winding axis is the direction of the axis of the condenser casing 2a, the two cooling coils 2b and 2c can be attached/detached to/from the condenser casing 2a by only moving the cooling coils 2b and 2c in the direction of the axis of the condenser casing 2a. That is, the attachment/detachment of the two cooling coils 2b and 2c to/from the condenser casing 2a is extremely easy.

In the condenser 2 according to the present embodiment, since the two cooling coils 2b and 2c are provided at a predetermined interval in a direction perpendicular to the axis of the condenser casing 2a, that is, in a radial direction of the cylindrical condenser casing 2a, the residual vapor moved from the cleaning chamber S1 to the condensing chamber G can be efficiently condensed.

In the condenser 2 according to the present embodiment, since the connection between the two cooling coils 2b and 2c is set outside the condenser 2 (the condenser casing 2a), the supplying state of the coolant to the two cooling coils 2b and 2c can be easily changed. For example, the connection of the two cooling coils 2b and 2c can be easily switched between the series connection and the parallel connection. For example, a device having a predetermined function, for example a temperature adjusting device for adjusting the temperature of the coolant or a flow rate adjusting device for adjusting the flow rate of the coolant can be easily inserted between the two cooling coils 2b and 2c connected in series.

In the condenser 2 according to the present embodiment, since the two cooling coils 2b and 2c are held by the holding member 2d that includes the lid member 2f, the rod members 2g, and the locking members 2h, the two cooling coils 2b and 2c can be simultaneously attached/detached to/from the condenser casing 2a by the holding member 2d. Thereby, the attachment/detachment of the two cooling coils 2b and 2c to/from the condenser casing 2a is further easy.

In the present embodiment, since the opening/closing mechanism 2e is provided on the condenser 2, a whole constitution of the device can be more simplified than the case where the opening/closing mechanism 2e is provided on the cleaner 1. For example, in the case where the opening/closing mechanism 2e is provided on the cleaner 1, a connection of the air cylinder 2m as the driving source to the valve body 2i is complicated, and thereby a whole constitution of the vacuum cleaning device is complicated.

In the present embodiment, since the cylindrical condenser 2 (the cylindrical condenser casing 2a) is provided in a vertical direction, an installation space of the vacuum cleaning device can be reduced. For example, in the case where the condenser 2 (the condenser casing 2a) is provided in a horizontal posture, a wider installation space is required.

The present disclosure is not limited to the above embodiment, for example the following modifications are considered.

(1) In the present embodiment, the shape of the condenser 2 (the condenser casing 2a) is the cylindrical shape, but the present disclosure is not limited thereto. For example, the shape of the condenser 2 (the condenser casing 2a) may be a box shape. In the present embodiment, the holding member 2d is made up of the lid member 2f, the rod members 2g, and the locking members 2h, but the present disclosure is not limited thereto.

(2) In the present embodiment, the single condenser 2 is provided on the single cleaner 1, but the present disclosure is not limited thereto. For example, to improve the drying capacity, for example to further shorten a drying time, a plurality of condenser 2 may be provided on the single cleaner 1.

(3) In the present embodiment, the two cooling coils 2b and 2c are adopted as the cooling pipes, but the present disclosure is not limited thereto. For example, cooling pipes folded in a staggered shape other than the coil shape may be used. The number of cooling pipes is not limited to two, and may be one or two or more.

(4) In the present embodiment, the vacuum cleaning device adopts the constitution of performing the vapor-cleaning treatment, the dip-cleaning treatment, the shower cleaning treatment, and the drying treatment, but the present disclosure is not limited thereto. The cleaning treatment performed in the cleaning chamber S1 may be only the vapor cleaning or the shower cleaning.

In a cleaning device that adopts drying mode using a condenser, the maintainability of the condenser can be improved.

What is claimed is:

1. A cleaning device comprising at least:
a main body including a vapor cleaning chamber configured to perform vapor-cleaning on a workpiece and a dipping cleaning chamber configured to perform dip-cleaning on the workpiece; and
a condenser provided on the vapor cleaning chamber to be capable of switching between a communication state and a non-communication state with the vapor cleaning chamber via a vapor inlet port, and configured to condense vapor taken in from the vapor inlet port,
wherein the condenser includes:
a condenser casing in which the vapor inlet port is formed;
a cooling pipe through which a coolant flows; and
a holding member that holds the cooling pipe to detachably house the cooling pipe in the condenser casing.

2. The cleaning device according to claim 1, wherein the cooling pipe includes a plurality of cooling pipes provided in the condenser casing, and connection of the cooling pipes is set outside the condenser casing.

3. The cleaning device according to claim 1,
wherein the holding member includes:
a lid member that blocks an attachment/detachment port formed in the condenser casing;
a rod member, one end of which is fixed to the lid member, and
a locking member that is provided in a predetermined place of the rod member and is configured to lock the cooling pipe.

4. The cleaning device according to claim 1, further comprising an opening/closing mechanism configured to open and close the vapor inlet port.

5. The cleaning device according to claim 1, wherein:
the condenser casing has a columnar shape; and
the cooling pipe is formed in a coil shape in which a direction of a winding axis corresponds to a direction of an axis of the condenser casing.

6. The cleaning device according to claim 5, wherein the cooling pipe includes a plurality of cooling pipes provided at a predetermined interval in a direction perpendicular to the axis of the condenser casing.

7. The cleaning device according to claim 5, wherein the condenser casing is disposed in a vertical direction.

8. The cleaning device according to claim 1, wherein the condenser includes a plurality of condensers.
